(19) United States
(12) Patent Application Publication
(10) Pub. No.: US 2009/0211687 A1
(43) Pub. Date: Aug. 27, 2009

(54) Method for manufacturing multilayer electronic component

(75) Inventors: Toshihiro Iguchi, Tokyo (JP); Akitoshi Yoshii, Tokyo (JP); Akira Goshima, Nikahoshi (JP); Kazuyuki Hasebe, Nikahoshi (JP)

Correspondence Address: OLIFF & BERRIDGE, PLC, P.O. BOX 320850, ALEXANDRIA, VA, 22320-4850, US

(73) Assignee: TDK CORPORATION, TOKYO (JP)

(21) Appl. No.: 12/379,175

(22) Filed: Feb. 13, 2009

(30) Foreign Application Priority Data
Feb. 25, 2008 (JP) 2008-043472

(51) Int. Cl. B32B 37/00

(52) U.S. Cl. 156/60

(57) ABSTRACT

The present invention aims to provide a method for manufacturing a multilayer electronic component capable to remove a multilayer body very easily from the press mold without breaking the multilayer body when removing a green sheet multilayer body applied with a pressure from the press mold, furthermore has no waste of material, contributes to the environment conservation, and also easy to automate. Among the plurality of green sheets constituting a multilayer body 4a, the adhesive force of at least one of the outer green sheet 14a1 contacting to the lower mold 20 of the press mold 20 is made weaker compared to that of other green sheet 14a2, 10a, 14a3, and 14a4 of which are stacked with said outer green sheet 14a1. Next, a pressure is applied to the multilayer body 4a on the lower mold 20 of the press mold. Then, the press mold 25 is removed from the multilayer body 4a which is applied with the pressure.

### BACKGROUND OF THE INVENTION

### Field of the Invention

The present invention relates to a method for manufacturing a multilayer electronic component; and more specifically the present invention relates to a method for manufacturing the multilayer electronic component of which a multilayer body can be easily removed from a press mold without breaking the multilayer body when removing a green sheet multilayer body which is applied with pressure from the press mold.

For example, the multilayer electronic component such as a multilayer ceramic capacitor is manufactured by going through the steps of stacking plurality of ceramic green sheets having an internal electrode pattern; and applying a pressure to this multilayer body by the press mold. However, when removing the multilayer body after applying the pressure to the multilayer body of the green sheet, the multilayer body sticks to the surface contacting with the press mold, and the multilayer body may break or deform if removed forcibly.

In order to prevent such problem, for example, in Japanese Unexamined Patent 7-101690 and Japanese Unexamined Patent 8-167538 has a separation sheet or a separation film (hereinafter separation sheet) between the press mold and the multilayer body. However, in such method having the separation sheet, these separation sheets must be prepared a part from the green sheet, thus the process becomes complicated.

Also, it is a waste of a material to prepare and discard the separation sheet every time applying a pressure to the multilayer body; and an effect to the environment is also concerned. Furthermore, it is necessary to have an automated replacement of the separation sheet, and thus a cost for the equipment increases.

### SUMMARY OF THE INVENTION

The present invention is achieved reflecting such situation. The present invention aims to provide a method for manufacturing a multilayer electronic component capable to remove a multilayer body very easily from the press mold without breaking the multilayer body when removing a green sheet multilayer body applied with a pressure from the press mold, furthermore has no waste of material, contributes to the environment conservation, and also easy to automate.

In order to achieve the above mentioned aims, the method for manufacturing the multilayer electronic component according to the present invention comprises steps of
weakening an adhesive force of at least one of a first green sheet contacting with a press mold compared to that of an other second green sheet stacked along with said first green sheet among plurality of green sheets comprising a multilayer body,
applying a pressure to said multilayer body on said press mold, and
removing said multilayer body applied with pressure from said press mold.

In the method for manufacturing the multilayer electronic component according to the present invention, the adhesive force of at least one of the first green sheet contacting with the press mold is weakened compared to that of the other second green sheet. Thus, while the adhesive force of each green sheet in the multilayer body, which has been pressured, is sufficient, the multilayer body can be removed from the press mold very easily without breaking the multilayer body when removing the multilayer body, which has been pressured, from the press mold.

Furthermore, the method of the present invention does not use the separation sheet, thus it does not waste the material and contributes to the environment conservation. Also, since there is no need for the replacement of the separation sheet, the automation for applying the pressure to the multilayer body of the green sheet is easy.

Preferably, the drying condition of said first green sheet is made different compared to that of said second green sheet. By making the drying condition different, the adhesive force of the first green sheet can be weakened compared to that of the second green sheet.

For example, said first green sheet is heated while contacting with said press mold and dried, then said second green sheet is stacked. Thereby the first green sheet is drier than the second green sheet, and thus the adhesive force of the first green sheet becomes relatively lower. Moreover, in such case, the first green sheet may be dried by simply contacting to the press mold, and can attain significant effect without largely modifying the conventional steps.

Also, said first green sheet and second green sheet can be dried at different condition before stacking on to said press mold to weaken the adhesive force of the first green sheet compared to the second green sheet.

Alternatively, the adhesive force of the first green sheet can be weakened compared to that of said second green sheet by making the thickness of said first green sheet thinner than that of said second green sheet.

Alternatively, the adhesive force of the first green sheet can be weakened compared to that of said second green sheet by making the amount of the plasticizer included in said first green sheet less than that of said second green sheet.

Alternatively, the adhesive force of the first green sheet can be weakened compared to that of said second green sheet by making a type of plasticizer included in said first green sheet different from that of said second green sheet.

Alternatively, the adhesive force of the first green sheet can be weakened compared to that of said second green sheet by making the amount of a resin included in said first green sheet less than that of said second green sheet.

Furthermore, the adhesive force of the first green sheet can also be weakened compared to that of said second green sheet by making the glass transitional temperature Tg of the resin included in said first green sheet higher than that of said second green sheet.

### BRIEF DESCRIPTION OF THE DRAWINGS

Hereinafter, the present invention will be explained based on the embodiment shown in the figures.

FIG. 1 is a schematic cross section of the multilayer ceramic capacitor manufactured by the method according to an embodiment of the present invention.

FIG. 2 is a cross section of an essential part of the first green sheet indicating the manufacturing steps of the multilayer ceramic capacitor shown in FIG. 1.

FIG. 3 is a cross section of an essential part indicating the steps following FIG. 2.

FIG. 4 is a cross section of an essential part indicating the steps following FIG. 3.

### DESCRIPTION OF THE PREFERRED EMBODIMENTS

### First Embodiment

First, an over all constitution of a multilayer ceramic capacitor will be explained as an embodiment of a multilayer electronic component manufactured by the method according to the embodiment of the present invention.

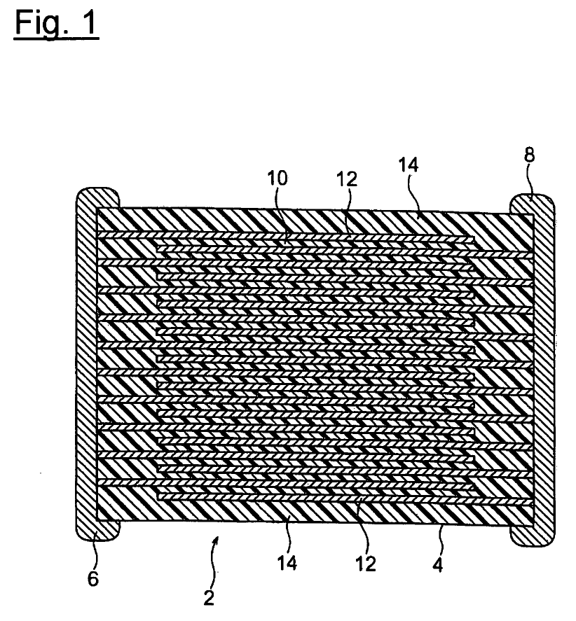

As shown in FIG. 1, the multilayer ceramic capacitor 2 according to the present embodiment comprises a capacitor element body 4, a first terminal electrode 6 and a second terminal electrode 8. The capacitor element body 4 comprises internal electrode layers 12 and the internal electrode layers are stacked in alternating manner between inner dielectric layers 10.

The capacitor element body 4 comprises outer dielectric layers 14 at the both end surfaces in the stacking direction thereof. One of the internal electrode layers 12 of which are stacked in alternating manner is electrically connected to the inside of the first terminal electrode 6 formed on the outside of the first terminal of the capacitor element body 4. Also, the other internal electrode layers 12 which are stacked in an alternating manner is electrically connected against the inside of the second terminal electrode 8 formed on the outside of the second terminal of the capacitor element body 4.

The material of these inner dielectric layers 10 and outer dielectric layers 14 are not particularly limited, and for example, it may be constituted by a dielectric material such as calcium titanate, strontium titanate and/or barium titanate. The thickness of each inner dielectric layer 10 is not particularly limited; however in general it is several μm to tens of μm. Also, the thickness of the outer layer part formed by the outer dielectric layer 14 is not particularly limited; however it is within the range of 10 to 200 μm.

The material for the terminal electrodes 6 and 8 are not particularly limited, however usually at least one from Ni, Pd, Ag, Au, Cu, Pt, Rh, Ru, and Ir or so, or an alloy thereof can be used. Usually, Cu, Cu alloy, Ni, Ni alloy, Ag, Ag—Pd alloy, or In—Ga alloy or so are used. The thickness of the terminal electrodes 6 and 8 are not particularly limited, however it is usually 10 to 50 μm or so. Note that, Ni plating and Sn plating may be performed to the terminal electrodes 6 and 8.

The shape and the size of the multilayer ceramic capacitor 2 can be determined according to the aim and use. In case the multilayer ceramic capacitor 2 is rectangular parallel shaped, usually the size is length (0.2 to 5.7 mm)×width (0.1 to 5.0 mm)×thickness (0.1 to 3.2 mm) or so.

Next, the method for manufacturing the multilayer ceramic capacitor 2 as an embodiment of the present invention will be explained.

First, the dielectric paste which forms the dielectric layers 10 and 14 shown in FIG. 1 are prepared. The dielectric paste is usually constituted by an organic solvent based paste or a water based paste which is obtained by kneading a ceramic powder and an organic vehicle. In the present embodiment, these pastes are preferably the organic based paste.

Note that, the organic vehicle is obtained by dissolving a binder in the organic solvent. The binder used in the organic vehicle is not particularly limited, and it can suitably be selected from usual various binders such as ethyl cellulose and polyvinyl butyral or so.

Also, the internal electrode paste for forming the internal electrode layers 12 shown in FIG. 1 can be obtained by kneading the above-mentioned organic vehicle with conducting materials consisting of various conducting metals and alloys; or various oxides which become the above-mentioned conducting materials after firing, organic metallic compound and resinate, or so. Note that, a ceramic powder may be included in the internal electrode paste as an inhibitor if necessary. The inhibitor has an effect to suppress the sintering of the conductive powder at the firing step.

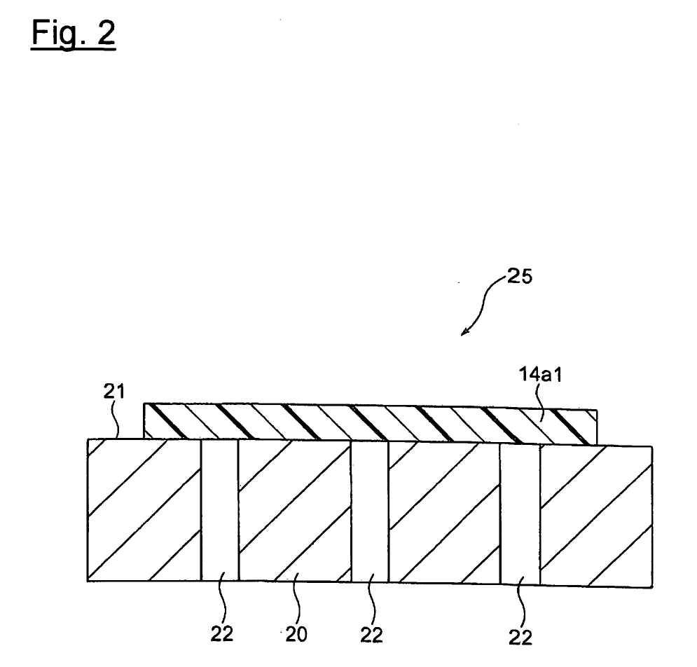

Next, by using the above dielectric paste, outer green sheets 14a1 to 14a4 and an inner green sheets 10a shown in FIG. 2 to FIG. 4 are formed, for example by pasting on to a flexible supporting body by doctor blade method followed by drying under the condition at about 80° C. for 10 seconds. The outer green sheets 14a1 to 14a4 are portions which become the outer dielectric layers 14 after the firing; and the inner green sheets 10a is a portion which becomes the inner dielectric layers 10 after the firing. These outer green sheets 14a1 to 14a4 and inner green sheets 10a may be formed by the same dielectric paste or it may be formed by different dielectric paste.

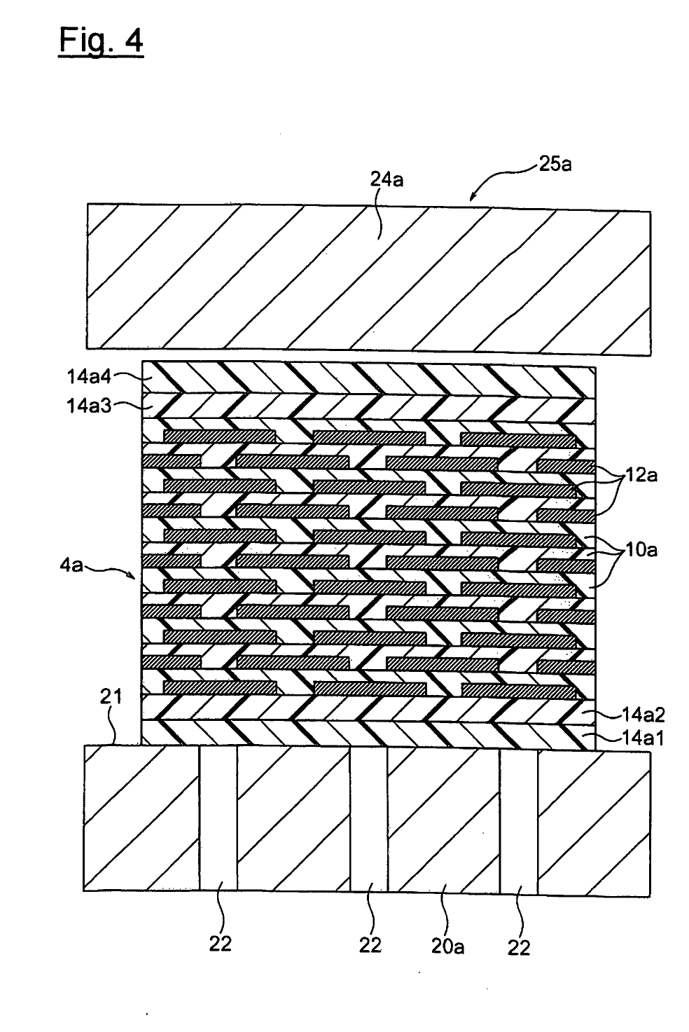

Note that, although in FIG. 4, two outer green sheets 14a1 and 14a2, or 14a3 and 14a4 are only illustrated on each side, more outer green sheets may be stacked. Also, as for the inner green sheets 10a, more green sheets may be staked than that shown in the figure.

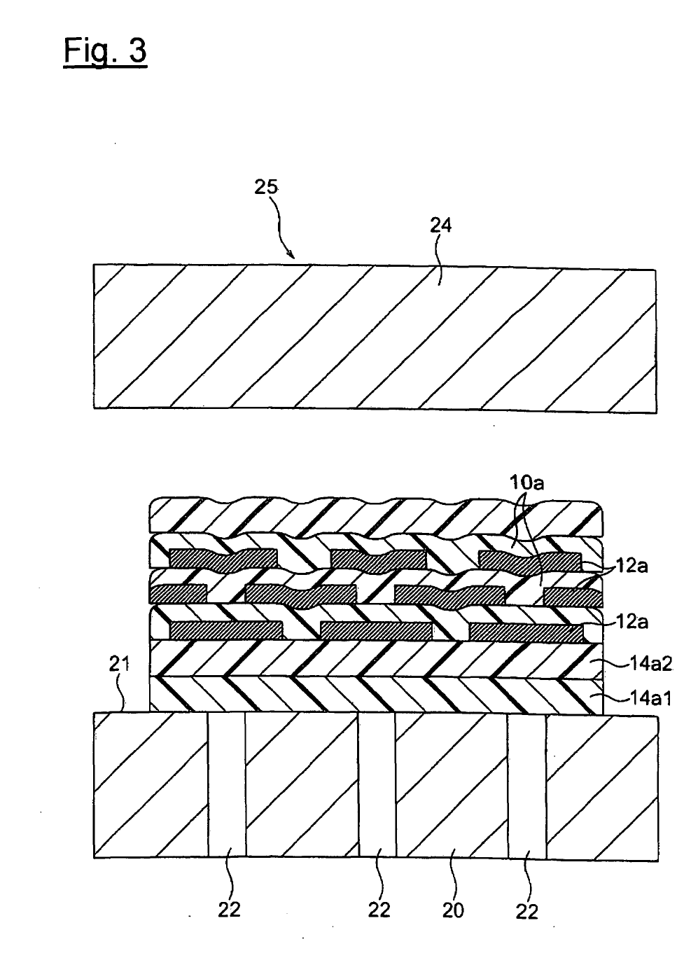

On each surface of the inner green sheet 10a, an internal electrode pattern 12a is formed by a screen printing using the above-mentioned internal electrode paste. As shown in FIG. 3, the inner green sheet 10a having the internal electrode pattern 12a is stacked alternately; and eventually at the top and the bottom of the inner green sheets 10a in the stacking direction, the outer green sheet 14a1, 14a2, 14a3, and 14a4 are stacked.

In this embodiment, as shown in FIG. 2, first, among the plurality of the outer green sheets 14a1, 14a2, 14a3 and 14a4 which are formed simultaneously and dried under the same drying condition, more than one of the outer green sheet 14a1 only is placed on the surface 21 of the lower mold 20 of the press mold 25. The lower mold 20 is provided with a suction hole 22 for the suction of the outer green sheet 14a1.

In this condition, only the outer green sheet 14a1 is further dried. For example, if the lower mold 20 is a lower mold of the pre-press mold, when pressing, it is performed by heating at about 40° C.; therefore the lower mold 20 thereof is provided with heating device to heat at about 40° C. There, only the outer green sheet 14a1 is dried for example at about 40° C. for about 30 seconds using the heating device. Note that, the temperature and the time for drying only the outer green sheet 14a1 can be changed accordingly. As a result of this drying, the adhesive force of the outer green sheet 14a1 can be reduced significantly by 5 to 80% compared to that of others.

Next, as shown in FIG. 3, another outer green sheet 14a2 and the other outer green sheets of which are not shown in the figure are stacked onto the dried outer green sheet 14a1. The inner green sheet 10a provided with the internal electrode pattern 12 is stacked thereon. As for the stacking, the green sheet may be transported onto the lower mold 20 for each layer to stack, or the multilayer body unit of which the plurality of green sheets are stacked by other press mold may be transported onto the lower mold to stack.

At any rate, another outer green sheet 14a2 and/or the inner green sheet 10a are stacked onto the outer green sheet 14a1 which is dried on the lower mold 20 as shown in FIG. 3. These outer green sheet 14a2 and/or inner green sheet 10a have stronger adhesive force compared to that of the outer green sheet 14a1 which is dried on the lower mold 20.

In case the lower mold 20 and the upper mold 24 are the pre-press mold, the pre-press treatment is performed for plurality of the green sheets, for example for every 8 to 9 sheets. At the pre-press, the pressure applied to the multilayer body from the upper mold 24 with respect to the lower mold 20 is not particularly limited, however for example it is 1 to 10 kgf/cm² or so. In the pre-press, eventually 20 to several thousands of green sheets are stacked. The pre-pressed multilayer body of the green sheet is then pressed by the same press mold. Alternatively, as shown in FIG. 4, the multilayer body 4a of the green sheet which has completed the pre-press is then transported onto the lower mold 20 of the press mold 25a and placed thereon.

At the press mold 25a, the pressure preferably of 10 to 30 kgf/cm² is applied to the multilayer body 4a at between the lower mold 20a and the upper mold 24a. The heating temperature at that time is not particularly limited, however for example it is about 70° C.

The multilayer body 4a finished with the press step is then cut to be a green chip. Then, the green chip is performed with a binder removal treatment and the firing treatment to be a sintered chip. The conditions for the binder removal treatment and firing treatment are not particularly limited, however, as for the firing temperature, for example, it is 1000 to 1400° C.

Then, the electrode paste, which becomes the first terminal electrode 6 and second terminal electrode 8 shown in FIG. 1, is pasted to the sintered chip, and the baking treatment is performed. The temperature condition or so at the baking treatment is not particularly limited.

In the method according to the present embodiment, the adhesive forth of at least one of the outer green sheet 14a1 contacting the lower mold 20 or 20a of the press mold 25, 25a is made weaker compared to that of the other green sheets 14a2, 10a, 14a3, and 14a4. Therefore, even though the adhesive forth of each of the green sheet in the multilayer body 4a which has been applied with the pressure is sufficient, when removed the multilayer body 4a which has been applied with the pressure from the lower mold 20, 20a of the press mold 25, 25a, the multilayer body 4a can be removed significantly easily without damaging it.

Note that, in the present invention, the adhesive forth of the outer green sheet 14a4 contacting with the upper mold 24a in the multilayer body 4a shown in FIG. 4 are the same as that of other green sheets 14a2, 10a, and 14a3. However, the outer green sheet 14a4 positioned on the upper side in the stacking direction rarely adheres to the upper mold 24a. This is thought to be caused by the rough surface of the green sheet which is the effect of the internal electrode pattern 12a placed intermittently under the green sheet, for example as shown in FIG. 3. The green sheet with the rough surface is difficult to adhere to the upper mold 24 and 24a.

Conventionally, the problem was that the outer green sheet 14a1 positioned at the lowest side in the staking direction adheres to the lower mold 20 or 20a. However, in the present embodiment, the adhesive force of at least one of the outer green sheet 14a1 contacting with the lower mold 20 or 20a is made weaker compared to that of the other green sheets 14a2, 10a, 14a3, and 14a4. Thus, the multilayer body 4a can be removed significantly easily without damaging.

Furthermore, the method of the present embodiment does not use the detachment sheet; hence no material is wasted and contributes to the environmental conservation. Also, since there is no need for changing the detachment sheet, the pressure to the multilayer body of the green sheet can be automated easily.

Moreover, the embodiment simply needs to dry the outer green sheet 14a1 positioned at the lowest side simply by contacting to the lower mold 20; thus significant effect can be obtained without making drastic change in the conventional steps.

### Second Embodiment

In the second embodiment of the present invention, before stacking on to the press mold 25 which is shown in FIG. 2, only the outer green sheet 14a1 which is stacked at the lowest side is dried in advance in a different condition compared to that of the other green sheets 14a2, 10a, 14a3, and 14a4. That is, it is dried so that the adhesive forth of the outer green sheet 14a1 is weaker than the other green sheets 14a2, 10a, 14a3, and 14a4. By making the drying condition different as such, the adhesive force of the outer green sheet 14a1 can be made weaker than the other green sheets 14a2, 10a, 14a3, and 14a4.

Specifically, the outer green sheet 14a1 alone is dried in advance in a higher drying temperature and/or for a longer drying time compared to that of the other green sheets 14a2, 10a, 14a3, and 14a4. Further specifically, the dielectric paste is dried at about 90° C. for 5 seconds to form a green sheet. Other constitutions and effects are the same as in the above mentioned first embodiment.

### Third Embodiment

In the third embodiment of the present invention, the thickness of the outer green sheet 14a1 which is stacked at the lowest side is made thinner compared to that of the other outer green sheet 14a2. Specifically, the thickness of the outer green sheet 14a1 is 20 to 80% or so thinner compared to that of the other outer green sheet 14a2. Further specifically, if the thickness of the outer green sheet 14a2 is 5 to 15 μm, then the thickness of the outer green sheet 14a1 is 1 to 12 μm. In order to form the sheet thin, the discharging amount of the doctor blade may be modified, or the moving speed of the film when pasting the dielectric paste may be made faster.

As such, for the same outer green sheet, the adhesive forth of the outer green sheets 14a1 can be made weaker compared to that of the other green sheets 14a2, 10a, 14a3, and 14a4 by making the thickness different. Other constitutions and effects are the same as in the above mentioned first embodiment. Also, since the sheet is thinner, it is easily dried and the adhesive forth can be controlled very easily.

### Forth Embodiment

In the forth embodiment of the present invention, before stacking the press mold 25 shown in FIG. 2, the outer green sheet 14a1 which is stacked at the lowest side is formed in advance by the paste having less amount of the plasticizer compared to that of the other outer green sheets 14a2, 14a3, and 14a4. That is, the outer green sheet 14a1 is formed by the dielectric paste with the amount of the plasticizer so that the adhesive forth of the outer green sheet 14a1 is weaker compared to that of the other green sheets 14a2, 10a, 14a3, and 14a4. As such, the adhesive forth of the outer green sheet 14a1 can be made weaker compared to that of the other green sheets 14a2, 10a, 14a3, and 14a4 by making the amount of the plasticizer different.

Specifically, the amount of the plasticizer included in the dielectric paste constituting the outer green sheet 14a1 is 30 to 95% less compared to that of the other outer green sheets 14a2, 14a3, and 14a4. As for the plasticizer, for example DOP (dioctyl phthalate), BBP (butyl benzyl phthalate), and DOA (dioctyl adipate) having the boiling point of about 384° C. may be mentioned as examples. Other constitutions and effects are the same as in the above mentioned first embodiment.

### Fifth Embodiment

In the fifth embodiment of the present invention, before stacking the press mold 25 shown in FIG. 2, the outer green sheet 14a1 which is stacked at the lowest side is formed in advance by the paste using different types of plasticizer compared to that of the other outer green sheets 14a2, 14a3, and 14a4. That is, the outer green sheet 14a1 is formed by the dielectric paste with the type of the plasticizer so that the adhesive forth of the outer green sheet 14a1 is weaker compared to that of the other green sheets 14a2, 10a, 14a3, and 14a4. As such, the adhesive forth of the outer green sheet 14a1 can be made weaker compared to that of the other green sheets 14a2, 10a, 14a3, and 14a4 by using different types of the plasticizer.

Specifically, the type of the plasticizer included in the dielectric paste which constitutes the outer green sheet 14a1 is BBP; and in accordance with that, the type of the plasticizer included in the dielectric paste which constitutes the other outer green sheets 14a2, 14a3, and 14a4 are DOP. Alternatively, the type of the plasticizer included in the dielectric paste which constitutes the outer green sheet 14a1 is DBP (dibutyl phthalate); and in accordance with that, the type of the plasticizer included in the dielectric paste which constitutes the other outer green sheets 14a2, 14a3, and 14a4 are DOP. Alternatively, the type of the plasticizer included in the dielectric paste which constitutes the outer green sheet 14a1 is DEP (diethyl phthalate); and in accordance with that, the type of the plasticizer included in the dielectric paste which constitutes the other outer green sheets 14a2, 14a3, and 14a4 are DOP. Other constitutions and effects are the same as in the above mentioned first embodiment.

### Sixth Embodiment

In the sixth embodiment of the present invention, before stacking the press mold 25 shown in FIG. 2, the outer green sheet 14a1 which is stacked at the lowest side is formed in advance by the paste having less amount of the resin compared to that of the other outer green sheets 14a2, 14a3, and 14a4. That is, the outer green sheet 14a1 is formed by the dielectric paste with the amount of the binder resin so that the adhesive forth of the outer green sheet 14a1 is weaker compared to that of the other green sheets 14a2, 10a, 14a3, and 14a4. As such, the adhesive forth of the outer green sheet 14a1 can be made weaker compared to that of the other green sheets 14a2, 10a, 14a3, and by making the amount of the binder resin different.

Specifically, the amount of the binder resin included in the dielectric paste which constitutes the outer green sheet 14a1 is 50 to 95% less compared to that of the other outer green sheets 14a2, 14a3, and 14a4. As for the binder resin, for example, polyvinyl butyral resin, polyvinyl acetal resin, and acrylic resin may be mentioned. Other constitutions and effects are the same as in the above mentioned first embodiment.

### Seventh Embodiment

In the seventh embodiment of the present invention, before stacking the press mold 25 shown in FIG. 2, the outer green sheet 14a1 which is stacked at the lowest side is formed in advance by the paste having higher Tg (glass transition temperature) of the binder resin compared to that of the other outer green sheets 14a2, 14a3, and 14a4. By having higher Tg, the adhesive forth of the sheet is weakened. That is, the outer green sheet 14a1 is formed by the dielectric paste of the binder resin having Tg so that the adhesive forth of the outer green sheet 14a1 is weaker compared to that of the other green sheets 14a2, 10a, 14a3, and 14a4. As such, the adhesive forth of the outer green sheet 14a1 can be made weaker compared to that of the other green sheets 14a2, 10a, 14a3, and 14a4 by making the Tg of the binder resin higher of which the outer green sheet 14a1 is stacked at the lowest side.

Specifically, Tg of the binder resin included in the dielectric paste which constitutes the outer green sheet 14a1 is 40 to 100° C.; and in accordance with that, Tg of the binder resin included in the dielectric paste which constitutes the outer green sheets 14a2, 14a3, and 14a4 are higher by 1° C. or more than that of the outer green sheet 14a1. The main component of the resin may be same in the outside and inside. Other constitutions and effects are the same as in the above mentioned first embodiment. Note that, Tg of the binder resin can be controlled by the number of the butyral group or the degree of polymerization of the resin.

Note that, the present invention is not limited to the above mentioned embodiment, and it can be variously modified within the scope of the invention.

For example, the method of the present invention is not limited to the multilayer ceramic capacitor, and it can be applied to other electronic components.

Hereinafter the present invention will be explained based on the further detailed example.

### EXAMPLES

### Example 1

This example 1 corresponds to the above mentioned first embodiment, and as shown in FIG. 2, the green sheet 14a1 having the thickness of 7 μm which has been detached from the flexible supporting sheet is heated on the press mold 25 at 40° C. for 30 seconds, and then, the green sheet 14a2 shown in FIG. 3 is press treated by stacking 50 layers in 1 second interval which is shorter than 30 seconds to obtain the multilayer body of the green sheet.

As for the binder resin included in these green sheet 14a1 and 14a2, polyvinyl butyral resin was used, the glass transition temperature was 67° C. as shown in the following Table 1 and 2; and the amount of the resin was 5.5 parts by weight with respect to 100 parts by weight of ceramic powder. Also, as for the plasticizer included in the green sheet, DOP was used as shown in the following Table 1 and 2; and the added amount of the plasticizer was 45 parts by weight with respect to 100 parts by weight of the binder resin.

When the attachment of the mold to the multilayer body of the green sheet was checked against the surface 21 of the lower mold 20 which is shown in FIG. 3, no attachment of the mold was confirmed. The results are shown in Table 1. In Table 1, the sample without the attachment of the mold was indicated ◯. Also, when the attachment of the mold was present, it was indicated ×. Note that, assuming that m is the weight of the multilayer body of the green sheet and g is gravity acceleration, the attachment of the mold was determined by whether the multilayer body of the green sheet has completely detached or not from the mold when a force of 1.5 times or more of mg was applied to lift the multilayer body from the mold.

TABLE 1
Sheet of the lowest layer

| | Dried after | | Dried before | | | | | | | |
|---|---|---|---|---|---|---|---|---|---|---|
| | dettaching | | detaching | | Thickness of | Plasticizer | | Resin | | |
| | Drying | Drying | Drying | Drying | the green | Amount of the | Type of the | Amount of | | Attachment to |
| | Temp. | time | Temp. | time | sheet | plasticizer | plasticizer | the resin | Tg | the mold |
| Comparative | — | — | — | — | 7 μm | 45PHR | DOP | 5.5PHP | 67° C. | X |
| Example 1 | 40° C. | 30 sec | — | — | 7 μm | 45PHR | DOP | 5.5PHP | 67° C. | ◯ |
| Example 2 | 70° C. | 30 min | — | — | 7 μm | 45PHR | DOP | 5.5PHP | 67° C. | ◯ |
| Example 3 | — | — | 90° C. | 5 min | 7 μm | 45PHR | DOP | 5.5PHP | 67° C. | ◯ |
| Example 4 | — | — | — | — | 4 μm | 45PHR | DOP | 5.5PHP | 67° C. | ◯ |
| Example 5 | — | — | — | — | 7 μm | 40PHR | DOP | 5.5PHP | 67° C. | ◯ |
| Example 6 | — | — | — | — | 7 μm | 45PHR | BBP | 5.5PHP | 67° C. | ◯ |
| Example 7 | — | — | — | — | 7 μm | 45PHR | DOP | 5.0PHP | 67° C. | ◯ |
| Example 8 | — | — | — | — | 7 μm | 45PHR | DOP | 5.5PHP | 71° C. | ◯ |

TABLE 2
The outer sheet other than the lowest layer

| | | Drying before | | | Plasticizer | | Butyral resin | |
|---|---|---|---|---|---|---|---|---|
| | | detachment | | Thickness of | Amount | | Amount | |
| Drying | | Drying | Drying | the green | of the | Type of the | of the | Degree of |
| Temp. | Time | Temp. | time | sheet | plasticizer | plasticizer | resin | polymerization |
| — | — | — | — | 7 μm | 45PHR | DOP | 5.5PHP | 67° C. |

### Example 2

As shown in Table 1, the multilayer body of the green sheet was obtained as same as Example 1 except for heating the green sheet 14a1 on the press mold 25 at 70° C. for 30 minutes. When the attachment of the mold to the multilayer body of the green sheet was checked, no attachment was found. The results are shown in Table 1.

### Example 3

This example corresponds to the above mentioned second embodiment in which before stacking on to the mold 25 as shown in FIG. 2, only the outer green sheet 14a1 which is stacked at the lowest side was dried in advance in a different condition compared to that of the other green sheets 14a2, 10a, 14a3, and 14a4. That is, the outer green sheet 14a1 which is stacked at the lowest side was dried in advance at 90° C. for 5 minutes before the flexible supporting sheet is detached; and such drying was not performed to the other green sheet 14a2.

After that, these green sheet 14a1 and 14a2 were stacked sequentially, and press treatment was performed to obtain the multilayer body of the green sheet. For other conditions, it is as same as Example 1. When the attachment of the mold to the multilayer body of the green sheet was checked, no attachment was confirmed. The results are shown in Table 1.

### Example 4

This example corresponds to the above mentioned third embodiment, and the thickness of the outer green sheet 14a1 which is staked at the lowest side was 4 μm which is thinner compared to that of the other outer green sheet 14a2 which was 7 μm. The drying condition of these green sheets is the same. Then, these green sheets 14a1 and 14a2 were stacked sequentially, and press treatment was performed to obtain the multilayer body of the green sheet. Other conditions were the same as example 1. When the attachment of the mold to the multilayer body of the green sheet was checked, no attachment was confirmed. The results are shown in Table 1.

### Example 5

This example corresponds to the above mentioned fourth embodiment, and the outer green sheet 14a1 which is stacked at the lowest side was formed in advance by the paste having less amount of the plasticizer compared to that of the other outer green sheet 14a2. Specifically, with respect to 100 parts by weight of the binder resin, the amount of the plasticizer of the outer green sheet 14a1 was 40 parts by weight which is less compared to the amount of plasticizer of 45 parts by weight of the other outer green sheet 14a2.

The drying condition of these green sheets 14a1 and 14a2 are the same. Then, these green sheet 14a1 and 14a2 were stacked sequentially, and press treatment was performed to obtain the multilayer body of the green sheet. When the attachment of the mold to the multilayer body of the green sheet was checked, no attachment was confirmed. The results are shown in Table 1.

### Example 6

This example corresponds to the above mentioned fifth embodiment in which the type of the plasticizer included in the dielectric paste constituting the outer green sheet 14a1 was BBP, and in accordance with that the type of the plasticizer included in the dielectric layer constituting the other similar outer green sheet 14a2 was DOP.

The drying condition of these green sheets 14a1 and 14a2 are the same. Then, these green sheet 14a1 and 14a2 were stacked sequentially, and press treatment was performed to obtain the multilayer body of the green sheet. When the attachment of the mold to the multilayer body of the green sheet was checked, no attachment was confirmed. The results are shown in Table 1.

### Example 7

This example corresponds to the above mentioned sixth embodiment, and the outer green sheet 14a1 which is stacked at the lowest side was formed in advance by the paste having less amount of the resin compared to that of the other outer green sheet 14a2. That is, with respect to 100 parts by weight of the ceramic powder, the content of the binder resin was 5.0 parts by weight, and that of the green sheet 14a2 was 5.5 parts by weight.

The drying condition of these green sheets 14a1 and 14a2 are the same. Then, these green sheet 14a1 and 14a2 were stacked sequentially, and press treatment was performed to obtain the multilayer body of the green sheet. When the attachment of the mold to the multilayer body of the green sheet was checked, no attachment was confirmed. The results are shown in Table 1.

### Example 8

This example corresponds to the above mentioned seventh embodiment, and the outer green sheet 14a1 which is stacked at the lowest side was formed in advance by the paste having higher Tg of the binder resin compared to that of the other outer green sheet 14a2. That is, Tg of the green sheet 14a1 was 71° C., and Tg of the green sheet 14a2 was 67° C.

The drying condition of these green sheets 14a1 and 14a2 are the same. Then, these green sheet 14a1 and 14a2 were stacked sequentially, and press treatment was performed to obtain the multilayer body of the green sheet. When the attachment of the mold to the multilayer body of the green sheet was checked, no attachment was confirmed. The results are shown in Table 1.

### Comparative Example

As same as example 1, the green sheet 14a1 and 14a2 was stacked on the mold 25 sequentially, and press treated to obtain the green sheet, except for the green sheet 14a1 was not heated in advance on the press mold 25. When the attachment of the mold to the multilayer body of the green sheet was checked, the attachment was confirmed. The results are shown in Table 1.

1. A method for manufacturing a multilayer electronic component comprising steps of
weakening an adhesive force of at least one of a first green sheet contacting to a press mold among plurality of green sheets constituting a multilayer body compared to that of an other second green sheet,
applying a pressure to said multilayer body on said press mold, and
removing said multilayer body applied with the pressure from said press mold.

2. The method for manufacturing the multilayer electronic component as set forth in claim 1, wherein a drying condition of said first green sheet is different from that of said second green sheet.

3. The method for manufacturing the multilayer electronic component as set forth in claim 2, wherein said first green sheet is dried by heating while contacting with said press mold, and then said second green sheet is stacked.

4. The method for manufacturing the multilayer electronic component as set forth in claim 2, wherein before stacking on said press mold, said first green sheet and said second green sheet are dried under different condition.

5. The method for manufacturing the multilayer electronic component as set forth in claim 1, wherein a thickness of said first green sheet is made thinner than a thickness of said second green sheet.

6. The method for manufacturing the multilayer electronic component as set forth in claim 1, wherein an amount of a plasticizer included in said first green sheet is made less than an amount of that included in said second green sheet.

7. The method for manufacturing the multilayer electronic component as set forth in claim 1, wherein a type of the plasticizer included in said first green sheet is different from a type of that included in said second green sheet.

8. The method for manufacturing the multilayer electronic component as set forth in claim 1, wherein the amount of a resin included in said first green sheet is made less than the amount of that included in said second green sheet.

9. The method for manufacturing the multilayer electronic component as set forth in claim 1, wherein a glass transition temperature of a resin included in said first green sheet is higher than that of said second green sheet.
